(19) United States
(12) Patent Application Publication
(10) Pub. No.: US 2012/0148814 A1
(43) Pub. Date: Jun. 14, 2012

(54) TRANSPARENT GLASS BODY, METHOD FOR THE PRODUCTION THEREOF, AND USE THEREOF

(76) Inventors: Marcus Neander, Eschweiler (DE); Corina Serban, Aachen (DE)

(21) Appl. No.: 13/142,806

(22) PCT Filed: Feb. 5, 2010
(86) PCT No.: PCT/EP2010/051446

§ 371 Date: Feb. 29, 2012

(30) Foreign Application Priority Data
Feb. 9, 2009 (DE) 10 2009 008 141.0

(51) Int. Cl. B32B 17/06; B32B 3/26; B32B 5/18; C03B 8/00; C03C 15/00; B82Y 40/00; B82Y 30/00

(52) U.S. Cl. 428/216; 65/17.2; 977/780; 977/755; 977/888; 977/892

(57) ABSTRACT

The present invention relates to a transparent glass body that comprises at least one antireflective glass surface (2) constructed on at least one surface of the transparent glass body and at least one glasslike protective coating (3) applied to the antireflective glass surface (2). The portion of reflected radiation E_{R} is minimized and the transmitted radiation E_{T} is increased accordingly. The contamination amount K can penetrate the antireflective surface only to a very reduced extent. Degradation caused by weathering is minimized.

The present invention further relates to a method for the production as well as to uses of a transparent glass body.

The present invention relates to a new, transparent glass body with an antireflective glass surface.

Moreover, the present invention relates to a new method for the production of a new, transparent glass body with an antireflective glass surface.

Moreover, the present invention relates to the use of a new, transparent glass body with an antireflective glass surface in construction glazing, architectural glazing, or motor vehicle glazing, as well as in products for photovoltaic and solar-thermal energy conversion.

Dereflection of glass surfaces can be realized by various measures. In interference-optical layer systems, part of the reflected radiation is extinguished by destructive interference by coating the glass surface with two or more thin layers having different refractive indexes. A method is known, for example, from U.S. Pat. No. 6,495,203 B2.

Alternatively, dereflection can be effected by a single layer system if its refractive index corresponds to roughly the mathematical root of the refractive index of the material thereunder. The adjustment of the refractive index can be effected for the single layer system by skeletonizing the glass surface or coating the glass surface with a porous film. A conventional method of generating glass surfaces with a coating with a porous silicate film is disclosed in the Patent DE 101 46 687 C1. From DE 10 2005 020 168 A1, application of an additional hydrophobic coating to increase the long-term stability of porous silicate films is known.

A method for the production of a transparent glass body with a skeletonized surface is disclosed in DE 822 714 B. From U.S. Pat. No. 6,929,861 A, a skeletonized glass surface is known that has improved cleaning properties due to its structure.

Porous or skeletonized glass surfaces and coatings degrade under weathering, in particular through the presence of moisture. The relatively large, freely exposed surface of porous or skeletonized glass surfaces and coatings may be considered as a cause.

An object of the present invention is to provide a new, transparent, glass body that has a weather-resistant antireflective surface.

Another object of the present invention is to provide a new method for the production of new transparent glass bodies that delivers transparent antireflective glass bodies that have weather-resistant surfaces in large quantities, in a simple and very well reproducible manner.

Another object of the present invention is to find a new use of the new, transparent glass bodies in construction glazing, architectural glazing, or motor vehicle glazing, as well as in products for photovoltaic and solar-thermal energy conversion.

The present invention provides a transparent glass body that comprises
a. at least one antireflective glass surface constructed on at least one surface of the transparent glass body and
b. at least one glasslike protective coating applied to the antireflective glass surface.

In the following, the antireflective, transparent, and weather-resistant glass body is referred to as “glass body according to the invention”.

Moreover, the new method for the production of an antireflective, transparent, and weather-resistant glass body has been found, wherein
I) by application of a dereflection solution on at least one glass surface, a skeletonized surface is obtained,
II) the composition is rinsed from the skeletonized surface,
III) a sol-gel solution is applied on the transparent glass body with the skeletonized surface,
IV) a coating is produced by drying the composition at 20° C. to 200° C. on the skeletonized surface,
V) a glasslike protective coating is obtained from the coating by thermal treatment at 200° C. to 750° C.

In the following the method for the production antireflective, transparent, and weather-resistant glass bodies is referred to as “method according to the invention”.

And, last but not least, the new use of the glass body according to the invention in construction glazing, architectural glazing, or motor vehicle glazing, preferably as glass for products of photovoltaic and solar-thermal energy conversion, which is referred to in the following as “use according to the invention”.

The method according to the invention enables, reproducibly, the production of large quantities of glass bodies according to the invention that have high weather-resistance while retaining the antireflective action of the skeletonized surface.

The sum of transmitted, reflected, and absorbed electromagnetic radiation corresponds to the incident energy. Under the assumption that the absorption through a transparent glass body remains constant, a reduction of reflection on the interfaces of a body, called dereflection leads to an increase in transmittance. Through dereflection, the portion of radiation reflected at interfaces, e.g., air to glass or glass to air, is reduced.

The refractive index denotes the refraction or directional change and the reflection behavior of electromagnetic radiation upon incidence on an interface of two media. Also, the refractive index is the ratio between the phase velocity of light in a vacuum and its phase velocity in the respective material.

The adjustment of the refractive index to the dereflection in the single layer system is obtained by a skeletonized surface. Because of the voids, the mean phase velocity of the light through the skeletonized layer increases and, thus, the refractive index decreases. The skeletonized glass surface has a layer thickness of 30 nm to 1000 nm, preferably, a layer thickness of 50 nm to 200 nm. A skeletonized glass surface contains silicates that are separated from each other by defined voids. The mean width of the voids is in the range from 0.1 nm to 200 nm and, preferably, from 0.5 nm to 50 nm. The dimension of the voids into the depths of the glass body determines on average the thickness of the skeletonized glass surface.

With a refractive index of approx. 1.22 at the air-to-glass interface, reflection, in particular for visible light, is minimized. The refractive index of the skeletonized glass surface is in the range from 1.22 to 1.45 and, preferably, in the range from 1.25 to 1.40. Taken as a whole, the structure is an optimization based on the refractive index to be obtained, the layer thickness, and the layer stability of the skeletonized glass surface.

Through the production process of the skeletonized glass surface, small amounts of fluorine compounds remain in the skeletonized surface, preferably fluorides and fluoro complexes and, in particular, HF, SiF and NaF and/or mixtures thereof. Together with moisture, for example, through weathering, the degradation of the skeleton is intensified.

It has been found that the protective coating according to the invention prevents degradation of the antireflective layer caused by weathering. The purpose of the protective coating is to minimize the penetration of moisture, organic and/or inorganic contaminants into the voids of the skeleton-like structure.

Here, degradation means the decrease in transmittance through full or partial destruction of an antireflective layer and/or of the transparent glass body. Weathering usually begins directly after the production of a product and includes storage, transport, further processing, and the complete lifecycle of the product.

Weathering tests can be performed using accelerated climate exposure. In DIN-EN 61215:2005, Test 10.13, a moisture/heat test at a temperature of 85° C. and 85% relative humidity for a test period of 1000 h for the product lifecycle of photovoltaic modules, corresponding to roughly 20 years in outdoor weathering in moderate latitudes is described.

The protective coating against degradation does not fill the voids of the skeletonized layer, or fills them completely or partially up to 50%. In addition, a closed and continuous layer is present over the skeletonized layer not completely filled or filled partially up to 50%. The thickness of the protective coating is 5 nm to 1000 nm and, preferably, 10 nm to 200 nm. Because of the covering of the skeletonized glass surface with the protective coating, the dereflection of the surface persists.

The protective coating contains metal oxides or metalloid oxides, preferably oxides of Si, Ti, Zr, Al, Sn, W, Ce, and, particularly preferred, silicates. Absorption of sunlight in the protective coating itself is minimal to completely negligible depending on the layer thickness of the protective coating.

At an air-to-glass interface at normal incidence of light, reflection losses are roughly 4%. A highly transparent glass sheet with negligible absorption thus has a transmittance of roughly 92%. On a highly transparent glass, energy transmittance according to DIN-EN 410:1998 of >93% is achieved with one-sided dereflection. Considering the various highly absorbing glass types, the glass body according to the invention, including the skeletonized surface and protective layer, has energy transmittance according to DIN-EN 410:1998 of >80%, preferably >90% and particularly preferably >93%.

The energy transmittance of a body is calculated according to DIN-EN 410:1998 from the mathematical convolution of its transmittance spectrum with a weighted solar spectrum in the range from 300 nm to 2500 nm. Energy transmittance is a characteristic variable of glazings in radiation physics.

When transparent glass bodies are used for direct heat production, for example, in solar-thermal energy or in building glazing, energy transmission is a characteristic variable for the heat input. In products of solar-thermal energy, the radiation energy of the sun is preferably absorbed over the complete spectrum from 300 nm to 2500 nm in suitable heat exchangers. Preferably, liquids that contain, in particular, water or thermally stable organic compounds are used as primary storage media. The heat can be used primarily or secondarily as process heat or useful heat in private homes or in industry.

Photovoltaic modules have a series circuit of solar cells that are used for the direct conversion of sunlight into electrical energy. Solar cells contain semiconductor material, in particular silicon with an amorphous to monocrystalline structure, compound semiconductors containing cadmium, tellurium, and/or the group of chalcopyrites containing copper, indium, gallium, selenium, and/or alloys or mixtures thereof. The spectral sensitivity is particularly high for a large number of solar cells in a spectral range from 400 nm to 1100 nm. Dereflection for this wavelength range results in an increase of the transmittance of light to the solar cells and, thus, to an increase in the electrical efficiency of photovoltaic modules.

The glass bodies according to the invention are, preferably, used for covering photovoltaic modules. Based on the calculation according to DIN-EN 410:1998, a radiation physics characteristic variable can be calculated over the limited range from 400 nm to 1100 nm.

The glass bodies according to the invention can have various spatially extensive or planar shapes. They can be slightly or highly bent or curved in multiple spatial directions. The area of the glass body according to the invention can vary broadly and is determined by the respective purpose for use in the context of the use according to the invention. They can have an area of a few square centimeters in motor vehicle glazing up to several square meters for construction glazing. As cover glasses for solar-thermal energy and photovoltaics, they have an area of 0.5 m² to 3 m². The sheet thickness is 1 mm to 20 mm, preferably 2.5 mm to 4.5 mm.

Hardening of the glass body is necessary depending on use, particularly in response to safety requirements in construction glazing, architectural glazing, or motor vehicle glazing. By means of partial pretensioning or pretensioning, the mechanical stability and fracture behavior of a glass sheet are increased. For applications in the construction field, the requirements of DIN-EN 12150:2000, in particular, must be met; for applications in photovoltaics, the requirements of DIN-EN 61730:2005, in particular, must be met.

In the method according to the invention for the production of the transparent glass body, the surface of the glass body is skeletonized by application of a solution. The solution is composed substantially of H₂SiF₆ as well as dissolved SiO₂. The dissolved SiO₂ is used in a concentration of up to 3 millimole per liter above the saturation concentration. A method for this is known from DE 822 714 B.

The solution is applied by spray, dip, or flow methods. The type of application of the solution is of essential importance for the quality of the layer to be produced. Preferably, a dip method is used. In the case of similar sheets, a plurality of sheets can be dipped vertically into the solution. An advantage of the method according to the invention is the high degree of automation. In the so-called “batch” method, a plurality of bodies are processed in parallel in the essential process steps and high throughput with consistent quality is obtained. A batch comprises a plurality of similar transparent glass bodies, often in a frame. The frames with the transparent glass bodies are transported in parallel from process stage to process stage.

In an optional preliminary stage, the transparent glass bodies are cleaned. Any type of contaminants or inhomogeneities can affect the process that is used for skeletonization, which ultimately can lead to inhomogeneous dereflection. The cleaning process is carried out in a plurality of stages and, preferably, with demineralized water. After an optional drying step, the cleaned transparent glass bodies are transported on a frame into a cascade of temperature-controlled pools. In a first stage, the surface of the transparent glass body to be skeletonized is pretreated in a solution containing sodium hydroxide or hydrogen fluoride. After one or a plurality of intermediate rinsing stages, the surface of the transparent glass body is skeletonized with the actual solution of H₂SiF₆ as well as dissolved SiO₂. The reaction rate and the form of the structures created are substantially determined by the set temperature and composition of the solution as well as the pretreatment of the surface. A skeletonized surface layer is formed from the glass volume. The ratio of voids to the remaining material substantially determines the refractive index. The skeletonization is concluded after one or a plurality of rinsing stages.

The protective coating is applied on the skeletonized surface from a solution over a plurality of process stages using a sol-gel method. The solution is applied by spray, dip, flow, or spin coating methods and then dried in one or a plurality of stages. The type of coating used and the characteristics of the solution have substantial influence on layer thickness and homogeneity. A dip method is preferred. The composition of the solution contains metal oxides or colloidal suspensions of silicon dioxides, preferably, Si-alkoxides, Ti-alkoxides, Zr-alkoxides, Al-alkoxides, Sn-alkoxides, W-alkoxides, Ce-alkoxides, particularly preferably tetraethyl orthosilicate, methyltriethoxysilane, and/or mixtures thereof.

The duration and temperature for the subsequent drying and thermal treatment are dependent on the reactivity of the solvent. The skeletonized glass surface wetted with the solution is dried at temperatures of 20° C. to 200° C., preferably at 25° C. A gel-film is produced. The gel-film is converted into a glasslike coating in a thermal treatment in the range from 200° C. to 750° C. The glasslike coating does not fill the voids, or fills them partially or completely and/or lies, as a closed layer, over the skeletonized surface of the transparent glass body. The heat necessary for the drying and thermal treatment can be supplied by heat radiation or heat conduction. Heat radiation can include shortwave light, visible light, as well as longwave infrared radiation. Alternatively, the heat input can occur through the heat conduction of the air.

The glass bodies according to the invention are used in the form of glass sheets, for example, as glazing in automobile construction, to prevent reflections bothersome to the driver in the vehicle interior. The glass bodies according to the invention are also used as display windows to prevent reflections bothersome to the observer.

The glass bodies according to the invention are, preferably, used as cover glasses for photovoltaics and solar-thermal energy.

The drawings depict:

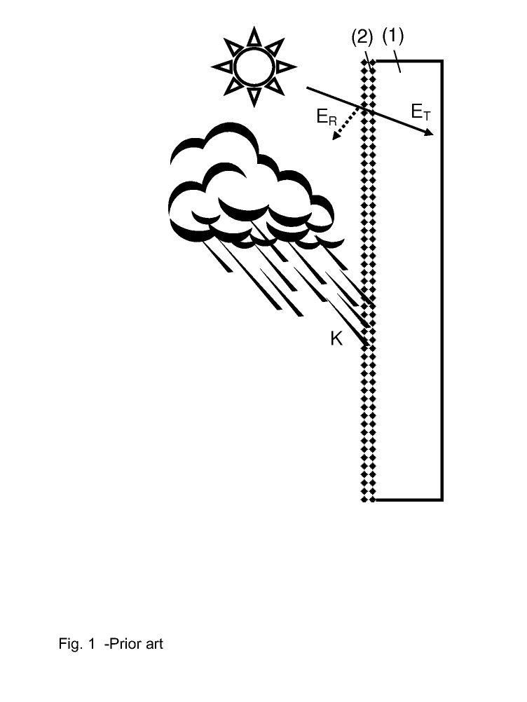

FIG. 1 a cross-section of a transparent glass sheet of the prior art,

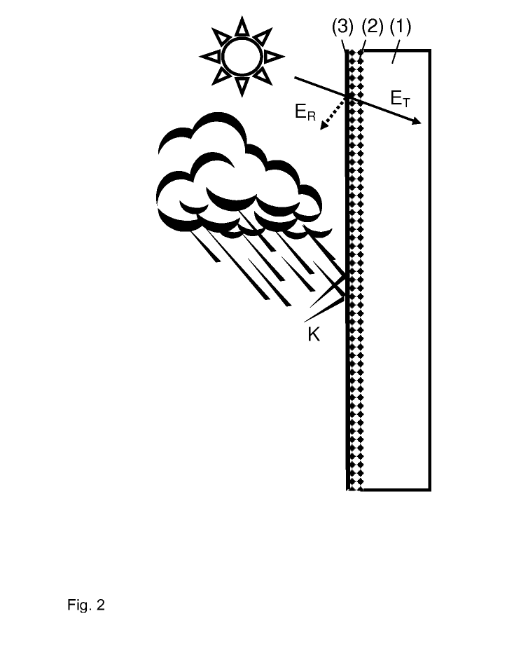

FIG. 2 a cross-section of a transparent glass sheet according to the invention,

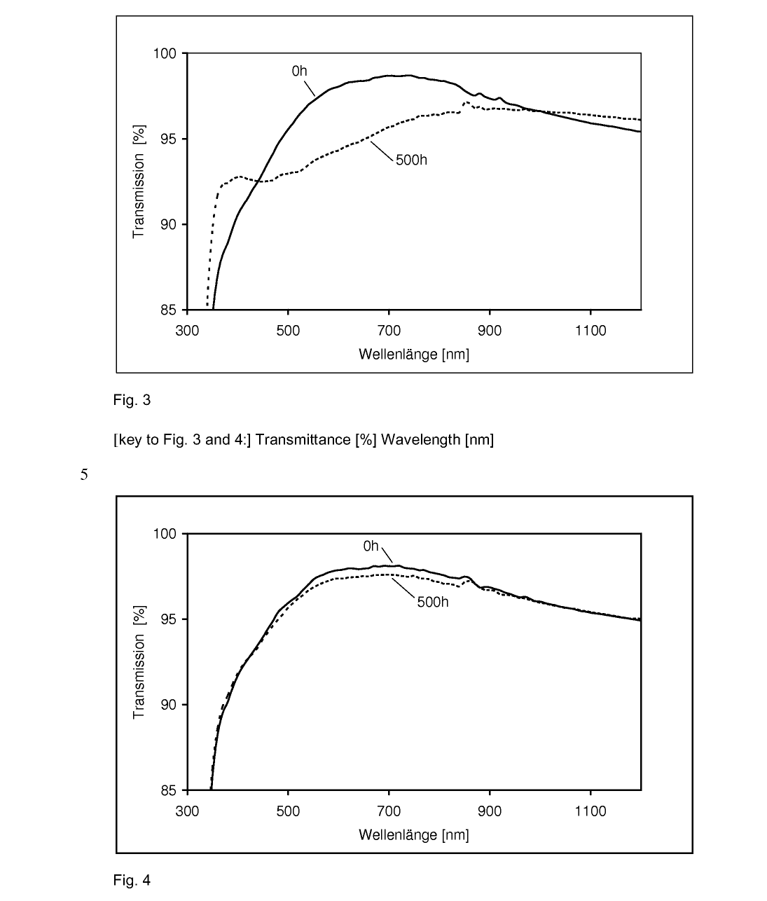

FIG. 3 two transmittance spectra of a transparent glass sheet of the prior art,

FIG. 4 two transmittance spectra a transparent glass sheet according to the invention.

FIG. 1 depicts a cross-section of a transparent glass sheet (1) of the prior art with a surface (2) antireflective on one side. The portion of reflected radiation E_{R} is minimized and the transmitted radiation E_{T} is increased accordingly. The contamination amount K, including organic and inorganic compounds, but, in particular, moisture, can penetrate into the antireflective surface unimpeded.

FIG. 2 depicts a cross-section of a transparent glass sheet (1) according to the invention with a surface (2) antireflective on one side and a protective layer. The portion of reflected radiation E_{R} is minimized and transmitted radiation E_{T} is increased accordingly. The contamination amount K can penetrate into the antireflective surface only to a very reduced extent. Degradation caused by weathering is minimized.

FIG. 3 depicts two transmittance spectra of a highly transparent, 3-mm-thick glass sheet (1) with a surface (2) antireflective on both sides without a protective layer, initially after 0 h and after accelerated weathering of 500 h in a moisture/heat test based on DIN-EN 61215:2005. It shows a clear decrease in the transmittance spectrum after weathering.

FIG. 4 depicts two transmittance spectra of a highly transparent, 3-mm-thick glass sheet with the surface antireflective on both sides with a protective layer, initially after 0 h and after accelerated weathering of 500 h in a moisture/heat test based on DIN-EN 61215:2005. The transmittance spectrum is largely unchanged by weathering.

The glass bodies according to the invention have an antireflective, weather-resistant surface. The portion of reflected radiation E_{R} of the interface air/glass or glass/air is minimized. The transmittance E_{T} through a glass body is thus increased. The adjustment of the refractive index to the dereflection is achieved by a skeletonized surface (2). Degradation caused by weathering is minimized by a glasslike protective coating (3). The glasslike coating (3) results in no increase in the radiation reflected on the surface.

### EXAMPLE

Two specimens #1 and #2 of non-pretensioned highly transparent glass sheets (1) with thicknesses of 3 mm were dereflected on both sides with a skeletonized surface (2). The specimen #2 was also protected on both sides according to the invention with a protective layer (3). The specimens were weathered for 500 h in a moisture/heat test based on DIN-EN 61215:2005. The transmittance spectra were measured in the initial state after 0 h and after 500 h and the energy transmittance values TE were calculated.

| | | TE | TE |
|---|---|---|---|
| | | (300-2500 nm) | (400-1100 nm) |
| Specimen | Weathering | [%] | [%] |
| #1 without | Initial | 95.4 | 96.7 |
| protective coating | Weathered 500 h | 94.9 | 95.5 |
| #2 with | Initial | 95.3 | 96.5 |
| protective coating | Weathered 500 h | 95.1 | 96.2 |

It was demonstrated that for the glass sheet with protective coating (3) according to the invention, Specimen #2, the transmittance values remained stable after weathering. This was particularly pronounced for the wavelength range between 400 nm and 1100 nm. In contrast, Specimen #1 without protective coating showed a drop in the transmittance values after weathering.

The transmittance spectra of the glass sheet without protective coating are presented in FIG. 3; the transmittance curves of the glass sheet according to the invention, in FIG. 4. In each case, the measured data are shown for the initial state 0 h and after weathering of 500 h in the moisture/heat test (500 h).

The comparison between Specimen #1 and Specimen #2 according to the invention shows that Specimen #2 according to the invention has a smaller drop in transmittance after weathering.

1. A transparent glass body, comprising:
a. at least one antireflective glass surface constructed on at least one surface of the transparent glass body and
b. at least one glasslike protective coating applied to the antireflective glass surface,
wherein the antireflective glass surface has a skeletonized structure with a layer thickness of 50 nm to 200 nm and the protective coating has a layer thickness of 10 nm to 200 nm.

2. The transparent glass body according to claim 1, wherein the antireflective glass surface has structures containing silicates and voids.

3. The transparent glass body according to claim 1, wherein the antireflective glass surface has mean structural depths of 30 nm to 1000 nm.

4. The transparent glass body according to claim 1, wherein the antireflective glass surface contains fluorine compounds.

5. The transparent glass body according to claim 1, wherein the antireflective glass surface has a refractive index of 1.22 to 1.45.

6. The transparent glass body according to claim 1, wherein the protective coating contains oxides of one or a plurality of metals.

7. The transparent glass body according to claim 1, wherein the transparent glass body, the antireflective glass surface, and the protective coating have an energy transmission according to DIN-EN 410:1998 of >80%.

8. The transparent glass body according to claim 1, wherein the transparent glass body is hardened.

9. A method for producing a transparent glass body, the method comprising:
applying a dereflection solution on at least one glass surface, thus obtaining a skeletonized surface,
rinsing the composition from the skeletonized surface,
applying a sol-gel solution on the transparent glass body with the skeletonized surface,
drying the composition at 20° C. to 200° C. on the skeletonized surface, thus producing a gel coating,
treating the produced gel coating at 200° C. to 750° C., thus producing a glasslike protective coating.

10. The method for producing a transparent glass body according to claim 9, wherein the contains H₂SiF₆ and colloidally dissolved SiO₂.

11. The method for the producing a transparent glass body according to claim 10, wherein dereflection solution comprises dissolved SiO₂ of up to 3 millimole per liter above the saturation concentration.

12. The method for producing a transparent glass body according to claim 9, wherein the sol-gel solution contains metal alkoxides or colloidal suspensions of silicon dioxides.

13. A method for using the a transparent glass body according to claim 1 the method comprising adapting the transparent glass body in construction glazing, architectural glazing, or motor vehicle glazing, preferably as glass for products of photovoltaic and solar-thermal energy conversion.

14. The transparent glass body according to claim 2, wherein the voids have the mean width of 0.1 nm to 200 nm, or 0.5 nm to 50 nm.

15. The transparent glass body according to claim 1, wherein the antireflective glass surface has mean structural depths of 50 nm to 200 nm.

16. The transparent glass body according to claim 1, wherein the antireflective glass surface contains fluorides and fluoro complexes.

17. The transparent glass body according to claim 4, wherein the fluorine compounds comprise HF, SiF, NaF, and a combination thereof.

18. The transparent glass body according to claim 1, wherein the antireflective glass surface has a refractive index of 1.25 to 1.40.

19. The transparent glass body according to claim 6, wherein the one or a plurality of metals is selected from the group consisting of Si, Ti, Zr, Al, Sn, W, Ce, and a combination thereof.

20. The transparent glass body according to claim 6, wherein the protective coating comprises silicates.

21. The transparent glass body according to claim 1, wherein the transparent glass body, the antireflective glass surface, and the protective coating have an energy transmission according to DIN-EN 410:1998 of >90%, or >93%.

22. The method for producing a transparent glass body according to claim 12, wherein the metal alkoxides or colloidal suspensions of silicon dioxides are selected from the group consisting of Si-alkoxides, Ti-alkoxides, Zr-alkoxides, Al-alkoxides, Sn-alkoxides, W-alkoxides, Ce-alkoxides, tetraethyl orthosilicate, methyltriethoxysilane and a combination thereof.
